(19) United States
(12) Patent Application Publication
(10) Pub. No.: US 2008/0166279 A1
(43) Pub. Date: Jul. 10, 2008

(54) CHEMICAL REACTION CARTRIDGE AND USING METHOD THEREOF

(75) Inventors: Takeo TANAAMI, Tokyo (JP); Hisao Katakura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Yokogawa Electric Corporation, Tokyo (JP)

(21) Appl. No.: 11/969,035

(22) Filed: Jan. 3, 2008

(30) Foreign Application Priority Data
Jan. 5, 2007 (JP) 2007-000395

(51) Int. Cl. B01J 19/00; B01L 3/00

(52) U.S. Cl. 422/236; 73/864.91

(57) ABSTRACT

Disclosed is a chemical reaction cartridge comprising: an elastic member as a component; a flow path and a plurality of chambers which are connected to each other by the flow path, the flow path or the chambers or both of the flow path and the chambers being partially blocked by applying external pressure to the elastic member from outside so that a fluid substance in the flow path or in the chambers is moved or blocked, and one of the chambers being a sample collecting chamber to temporarily retain a sample supplied from outside; an insert section to insert an injection needle to inject the sample into the sample collecting chamber; and a sealing member in which an opening to accept the injection needle inserted into the insert section is formed, and the opening is sealed to seal the insert section.

### BACKGROUND OF THE INVENTION

1. Field of the Invention

The present invention relates to a chemical reaction cartridge and a using method thereof.

2. Description of Related Art

In Japanese Patent Application Laid Open Publication No. 2005-037368, for the purpose of especially performing a combination, a dissolution, a detection, a decomposition, or the like of liquid solution in accordance with a predetermined protocol, without difference among individuals, in a low cost, safely and easily, a chemical reaction cartridge comprising an elastic member and a substrate made of a rigid body, is suggested. In the elastic body, a chamber and a flow path are formed, and by the elastic body, it is possible that the fluid flows and the flow of the fluid is blocked in the chamber and in the flow path. The substrate is made of the rigid body so as to maintain the position and the shape of the cartridge.

According to the invention described in Japanese Patent Application Laid Open Publication No. 2005-037368, the elastic member is deformed by a roller or the like to flatten out the chamber and the flow path. By moving or stopping the roller or the like in the state of the chamber and the flow path being flattened out, the flow and the flow blocking of the fluid are performed.

The chemical reaction cartridge is also used as a cartridge for biology (as a biochip) for the purpose of examining and analyzing DNA, RNA, protein or the like. In the paragraph 0033 and FIG. 21 in Japanese Patent Application Laid Open Publication No. 2005-037368, an invention is disclosed in which a concave portion is formed in an inlet of a sample such as blood, and the sample which has leaked is to be kept in the concave portion. After the injection of the sample, an injection needle is removed from the cartridge. According to the invention described in Japanese Patent Application Laid Open Publication No. 2005-037368, after the sample is injected, the sample can timely be sent to a preprocessing chamber, a reacting chamber or the like in the cartridge by pressing the roller or the like.

According to the invention disclosed in Japanese Patent Application Laid Open Publication No. 2005-037368, after the injection needle is removed from the cartridge, because of the existence of the concave portion surrounding an insert section, there is little of attaching the leaked sample to the surrounding substance. However, the danger of attaching the leaked sample to the surrounding substance may be caused. Further, the leaked sample is exposed to external air, and there may be danger depending on the material of the sample.

### SUMMARY OF THE INVENTION

The present invention is made in view of the above described problems in the conventional technique, and a main object of the present invention is to provide a chemical reaction cartridge and the using method thereof, which can be handled safely after the sample is injected.

According to a first aspect of the present invention, there is provided a chemical reaction cartridge comprising:

an elastic member as a component;

a flow path and a plurality of chambers which are connected to each other by the flow path, the flow path or the chambers or both of the flow path and the chambers being partially blocked by applying external pressure to the elastic member from outside so that a fluid substance in the flow path or in the chambers is moved or blocked, and one of the chambers being a sample collecting chamber to temporarily retain a sample supplied from outside;

an insert section to insert an injection needle to inject the sample into the sample collecting chamber; and

a sealing member in which an opening to accept the injection needle inserted into the insert section is formed, and the opening is sealed to seal the insert section.

According to a second aspect of the present invention, there is provided a method of using the chemical reaction cartridge, comprising:

inserting the injection needle into the insert section through the opening;

injecting the sample into the sample collecting chamber through the injection needle;

removing the injection needle;

sealing the opening; and

using the chemical reaction cartridge to examine the sample, in a state of the opening being sealed.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1A is a vertical sectional view of a chemical reaction cartridge according to a first embodiment of the present invention, and FIG. 1B is a perspective view thereof;

FIG. 2A is a vertical sectional view showing a condition in which a sample is injected into the chemical reaction cartridge according to a first embodiment of the present invention;

FIG. 2B is a vertical sectional view showing a condition in which the cartridge is sealed after the sample is injected;

FIG. 3 is a vertical sectional view of a chemical reaction cartridge according to a second embodiment of the present invention;

FIGS. 4A, 4B and 4C are vertical sectional views showing conditions of unsealing and sealing of the chemical reaction cartridge according to a third embodiment of the present invention;

FIGS. 5A and 5B are vertical sectional views showing a structure of the sealing of the chemical reaction cartridge according to a fourth embodiment of the present invention; and

FIGS. 6A and 6B are vertical sectional views showing a position determining structure of the chemical reaction cartridge according to a fifth embodiment of the present invention.

### DESCRIPTION OF THE PREFERRED EMBODIMENTS

Hereinbelow, embodiments of the present invention are described with reference to the drawings. In the description below, embodiments of the present invention are disclosed, and the present invention is not limited to these. Incidentally, the chemical reaction cartridge in the present invention is applied to a reactor vessel which is generally called as “a microreactor”. The present invention is not limited to a specific application.

### First Embodiment

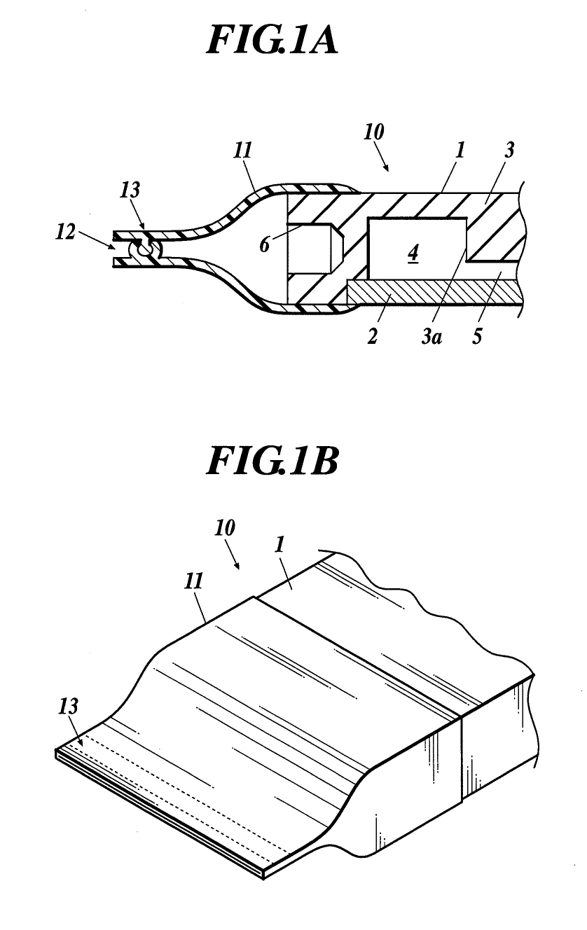

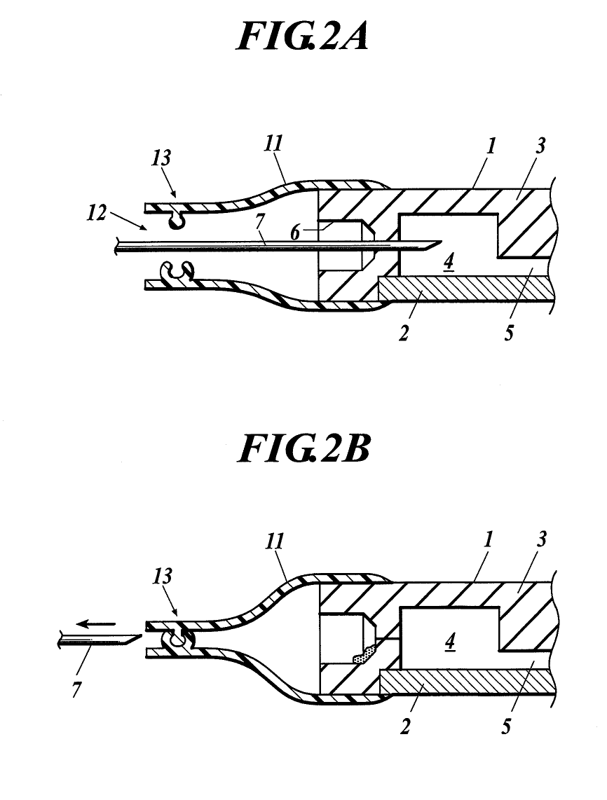

First, the first embodiment of the present invention is explained with reference to FIGS. 1A to 2B.

FIG. 1A is a vertical sectional view of the chemical reaction cartridge according to the first embodiment of the present invention, and FIG. 1B is a perspective view thereof.

As shown in FIGS. 1A and 1B, in the chemical reaction cartridge 10, a sealing member 11 is provided at an end portion of a cartridge main body 1. The cartridge main body 1 comprises an elastic member 3 such as rubber with airtightness and elasticity, and a substrate 2 made of a rigid body formed by a hard material for the purpose of determining a position and maintaining the shape of the chemical reaction cartridge.

As material of the elastic member 3, for example, silicon gum, polydimethylsiloxane (PDMS), natural rubber and a polymer thereof, acrylic rubber, and polyurethane rubber or the like is used.

As material of the substrate 2, for example, glass, metal, hard resin, and a rigid body which can be bended or the like is used.

As shown in FIG. 1A, a concave portion (for example, 3a) is formed on one surface of the elastic member 3. A portion of the surface of the elastic member 3, on which the concave portion is formed, except the concave portion, is attached to a surface of the substrate 2. Thus a flow path and chambers are formed. The number of the formed chambers is two or more. The flow path connects the chambers and makes a moving of a substance in between the chambers possible. The substance to be moved is for example, fluid substance, liquid and other substances with fluid property. When the reacting substance intended to be moved is one that does not flow or that is difficult to flow such as a solid substance, liquid solution including the reacting substance is placed into the chamber.

The flow path and the chambers may be formed so that they are entirely covered by the elastic member. Alternately, a portion of the wall section may comprise the elastic member. By positioning another layer of an elastic member in between the substrate 2 and the elastic member 3, the flow path and the chambers can be formed so that they are entirely covered by the elastic member. Alternately, an elastic member may be used instead of the substrate 2, and the cartridge may be comprised without the substrate made of the rigid body.

The moving of the substance is performed in a manner described below.

First, a pressing member such as a roller, a squeegee, a syringe or the like is pressed onto the flow path or the elastic member 3 on the chamber to flatten out the flow path or the chamber. By flattening out the flow path or the chamber, the substance inside can be flowed and can be moved. Further, by moving the pressing position, the substance inside can be flowed and can be moved in the moving direction of the pressing position. The moving of the pressing position is preferably performed in the following manner. That is, by contacting the internal walls opposing the flow path or the chamber at the pressing position, the flow path or the chamber is pressed to the state where the internal space is blocked.

The blocking of the moving substance is performed by contacting the internal walls opposing the flow path or the chamber and blocking the internal space by the pressing member. By using a plurality of pressing members, the following can be performed. That is, a substance may be moved by one pressing member. At the same time, the flow path or the chamber is pressed by another pressing member at the front of the substance in the moving direction to block the moving of the substance forward from the pressing position of another pressing member.

Based on the moving and the blocking described above, the moving of the substance in the cartridge main body 1 is controlled.

Based on the above described principle, the moving of the substance in the cartridge main body 1 is controlled, and an operation for a chemical reaction is performed.

As shown in FIG. 1A, in the cartridge main body 1, a sample collecting chamber 4, and a flow path 5 connected to the sample collecting chamber 4 are formed. The flow path 5 is connected to other chambers such as a preprocessing chamber (not shown).

At the end portion of the cartridge main body 1, an insert section 6 is formed. The insert section 6 is formed at the portion of the elastic member 3. The insert section 6 is formed in a sunken hole shape from the end surface of the cartridge main body 1 so as to be adjacent with respect to the sample collecting chamber 4. The bottom section of the gap of the insert section 6 is formed so as to be a partition wall with respect to the sample collecting chamber 4. By inserting the injection needle into the bottom section, the sample such as blood or the like can be injected. Incidentally, other than blood, anything collected from a biological body or nature may be used as the sample.

The sealing member 11 is provided so as to cover the end portion in which the insert section 6 is formed. The sealing member 11 and the cartridge main body 1 are joined airtightly by bonding or adhesion or the like. As a member to seal an opening 12 of the sealing member 11, the sealing member 11 comprises a rail fastener structure 13.

As shown in FIG. 2A, when the sample is injected, the rail fastener structure 13 is unfastened, and the opening 12 is opened. Incidentally, the opening 12 need not be closed before the sample is injected.

Next, the injection needle 7 connected to an injection syringe or the like is inserted into the sealing member 11 through the opening 12. Further, the injection needle 7 is inserted to the bottom section of the insert section 6, and the end thereof penetrates the sample collecting chamber 4. Moreover, after the sample is injected through the injection needle 7, the injection needle 7 is removed, and the rail fastener structure 13 is joined so that the opening 12 is sealed. Thus, the insert section 6 is sealed. It is enough for the opening 12 to have a size so as to be able to accept the injection needle 7.

As described above, the sample is injected into the sample collecting chamber 4, and the opening 12 is sealed quickly. Then, to open the opening 12 is avoided unnecessarily. The cartridge 10 is used for examining the sample such as blood, in the state where the opening 12 is sealed. Then, the cartridge 10 is discarded in the state where the opening 12 is sealed.

### Second Embodiment

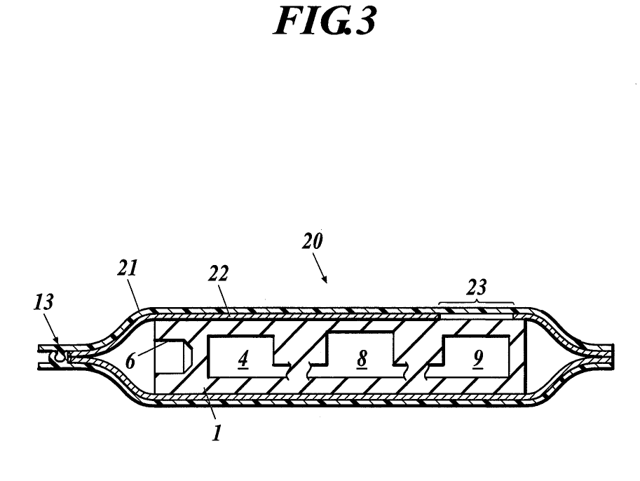

Next, the second embodiment of the present invention is explained with reference to FIG. 3.

A chemical reaction cartridge 20 in the embodiment comprises the cartridge main body 1, and a sealing member 21 which has a saclike shape for covering the entire cartridge main body 1. The sealing member 21 has a sac body which is transparent and is made of resin. The sealing member 21 is integrally formed with the rail fastener structure 13. The pressing to the elastic member by the roller or the like is performed from outside of the sealing member 21 to move the substance inside the cartridge main body 1. Thus, the sealing member 21 preferably has flexibility so that the pressing to the elastic member is not prevented.

A metal film 22 is formed on the inner surface of the sealing member 21. Incidentally, in the embodiment, it is also be effective that the metal film 22 is not used. By providing the metal film 22, and light blocking property is given to the sealing member 21 in the portion where the metal film 22 is provided. Thus, the alteration, deterioration or the like of the substance housed inside the cartridge main body 1, due to the irradiation of light, are prevented, and the storage stability of the substance can be increased. In order to give the light blocking property, coloring or the like may be performed instead of using the metal film.

The metal film 22 has an opening at a portion which corresponds to the detection window section 23. Thus, the transparency of the detection window section 23 is ensured. A chamber 9 is one for housing an object to be optically detected, such as DNA added with fluorescent material, or the like.

A chamber 8 is one for housing an object to be heated from outside. The heat conductivity to the chamber 8 is increased by the metal film 22. Thus the substance in the chamber 8 can be heated efficiently. The metal film 22 may be provided in a region immediately above the chamber 8, in a state of being isolated. Alternately, an opening may be provided on the sealing member 21 in the region immediately above the chamber 8 to expose the metal film 22 to outside. Thus the efficiency of the heat conductivity can further be increased. Alternately, the metal film 22 may be provided on the outer surface of the sealing member 21.

### Third Embodiment

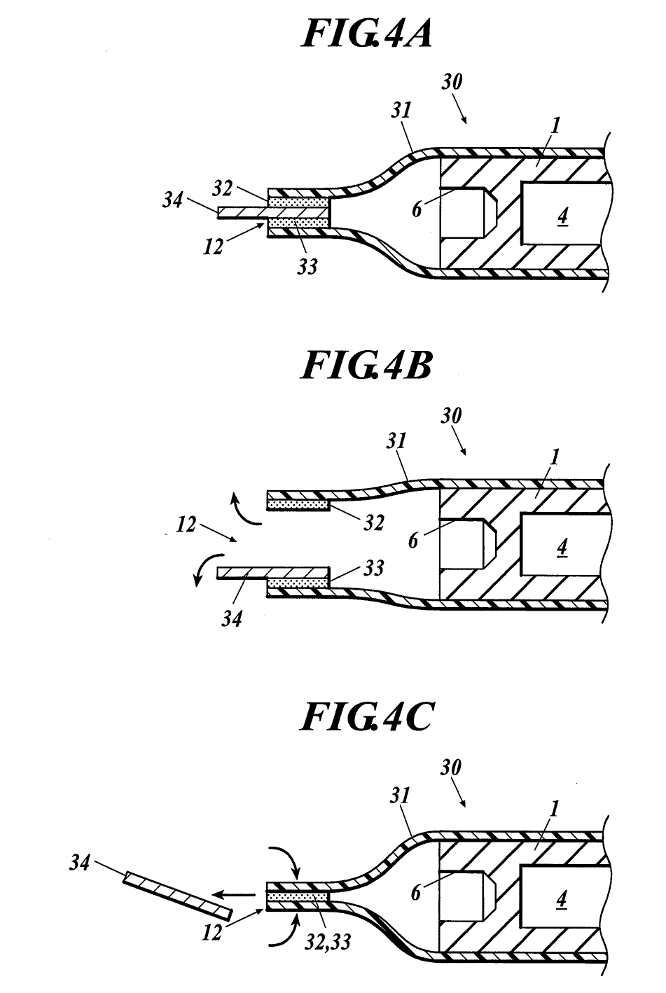

Next, the third embodiment of the present invention will be explained with reference to FIGS. 4A, 4B and 4C.

In the embodiment, as the sealing structure and method for the opening of the sealing member, other structures and methods are used. As shown in FIGS. 4A, 4B and 4C, the chemical reaction cartridge 30 of the embodiment comprises a sealing member 31 in the same manner as in the above described embodiments. On the inner surface of the end portion in the opening 12 side of the sealing member 31, sealing layers 32 and 33 made of sticking glue or adhesion bond are provided at the opposing regions. As shown in FIG. 4A, the sealing layers 32 and 33 are partitioned by a release paper 34.

As shown in FIG. 4B, the opening 12 can be opened by detaching either one of the sealing layers 32 or 33 from the release paper 34. When the opening 12 is opened and the injection of the sample is performed, the release paper 34 is peeled and removed from the sealing layers 32 and 33, and the sealing layers 32 and 33 are press-bonded to seal the opening 12, as shown in FIG. 4C.

Alternatively, in another example, the sealing layers 32 and 33 are not used, and the end portion of the opening 12 of the sealing member 31 is heat-sealed to seal the opening 12. That is, the matching peripheral portions which are extended to the opening 12 side of the sealing member 31 are heat-sealed to seal the opening 12.

### Fourth Embodiment

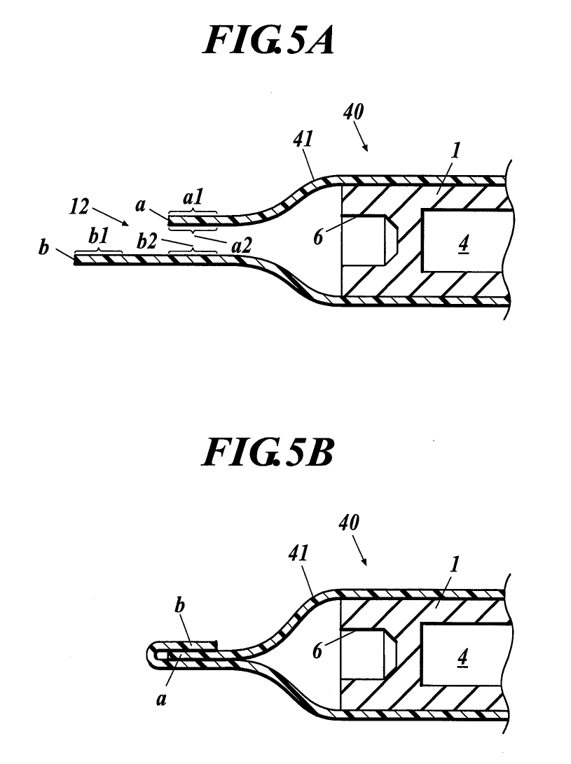

Next, the fourth embodiment of the present invention is explained with reference to FIGS. 5A and 5B.

In the embodiment, as the sealing structure and method the opening of the sealing member, other structures and methods are used. As shown in FIGS. 5A and 5B, the chemical reaction cartridge 40 of the embodiment comprises a sealing member 41 in the same manner as in the above described embodiments. The matching peripheral portions “a” and “b” in the opening 12 side of the sealing member 41 are formed so as to have different lengths.

Sealing layers are provided by sticking glue or adhesion bond on an outer surface a1 of the peripheral portion “a” and on an inner surface b1 of the peripheral portion “b”. Each of the release papers are peeled and the peripheral portion “b” is folded as a state shown in FIG. 5B to perform the sealing.

In addition, sealing layers may be provided by sticking glue or adhesion bond on an inner surface a2 of the peripheral portion “a” and on an inner surface b2 of the peripheral portion “b” which opposes thereto. Thus the hermetic sealing may be performed in the same manner as that of the above described third embodiment, to obtain double sealing.

Alternatively, it is also effective to perform the sealing of the opening 12 in the following manner. That is, instead of using sealings of sticking glue or adhesion bond, the peripheral portions “a” and “b” may be heat-sealed in a state of being folded as shown in FIG. 5B. In this case, it is preferable to perform both of the heat-sealings, that is, the sealing of an outer surface a1 of the peripheral portion “a” and the inner surface b1 of the peripheral portion “b”, and the sealing of the inner surface a2 of the peripheral portion “a” and the inner surface b2 of the peripheral portion “b” which opposes thereto, to obtain double sealing.

### Fifth Embodiment

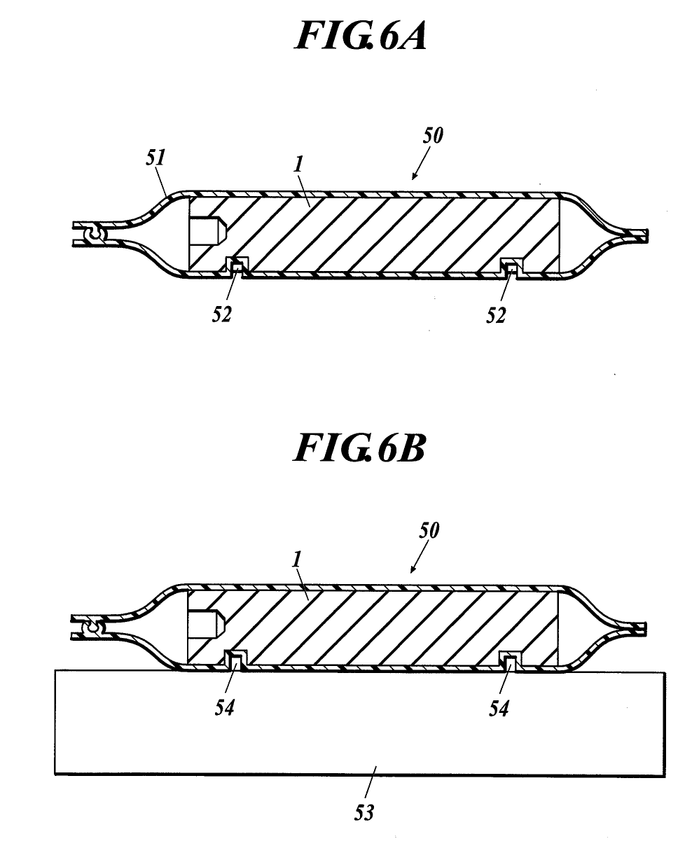

Next, the fifth embodiment of the present invention is explained with reference to FIGS. 6A and 6B.

In the embodiment, a structure and a method to determine a position of the cartridge are used.

As shown in FIGS. 6A and 6B, the chemical reaction cartridge 50 of the embodiment comprises a sealing member 51 in the same manner as in the above described embodiments. As shown in FIG. 6A, holes 52 and 52 are provided at a substrate portion of the back surface of the cartridge main body 1. Further, as shown in FIG. 6B, in order to fix the position, projections 54 and 54 are provided on a work table 53, and the projections 54 and 54 are respectively fixed to the holes 52 and 52 of the cartridge main body 1 in a state where the sealing member 51 is still intervening.

Other than to fix the projection 54 to the hole 52, an unevenness which is formed so as to be locked to an unevenness of the work table side may be provided on the back surface of the substrate. Thus the position is determined and fixed.

According to a first aspect of the preferred embodiments of the present invention, there is provided a chemical reaction cartridge comprising:

an elastic member as a component;

a flow path and a plurality of chambers which are connected to each other by the flow path, the flow path or the chambers or both of the flow path and the chambers being partially blocked by applying external pressure to the elastic member from outside so that a fluid substance in the flow path or in the chambers is moved or blocked, and one of the chambers being a sample collecting chamber to temporarily retain a sample supplied from outside;

an insert section to insert an injection needle to inject the sample into the sample collecting chamber; and

a sealing member in which an opening to accept the injection needle inserted into the insert section is formed, and the opening is sealed to seal the insert section.

Preferably, the sealing member comprises one of a rail fastener structure, a bonding sealing and an adhesive sealing for sealing the opening.

Preferably, the sealing member has a saclike shape so as to cover an entire cartridge main body.

Preferably, the chemical reaction cartridge comprises:

a substrate made of a rigid body to maintain a form of a surface on which the flow path and the plurality of chambers are formed, the substrate being provided on a back surface of the cartridge main body, wherein

an unevenness to lock the cartridge main body when a position of the cartridge is determined, is formed on a back surface of the substrate.

Preferably, a light blocking property is given to an entire or a part of the sealing member.

Preferably, a detection window section which has transparency is provided in the sealing member at a portion which covers one of the plurality of chambers in which an object to be optically detected is housed.

Preferably, a metal film is provided in the sealing member at least at a portion which covers one of the plurality of chambers in which an object to be heated from outside is housed.

According to a second aspect of the present invention, there is provided a method of using the chemical reaction cartridge, comprising:

inserting the injection needle into the insert section through the opening;

injecting the sample into the sample collecting chamber through the injection needle;

removing the injection needle;

sealing the opening; and

using the chemical reaction cartridge to examine the sample, in a state of the opening being sealed.

Preferably, the method of using the chemical reaction cartridge comprises:

inserting the injection needle into the insert section through the opening;

injecting the sample to the sample collecting chamber through the injection needle;

removing the injection needle;

sealing the opening;

using the chemical reaction cartridge to examine the sample, in the state of the opening being sealed; and

discarding the chemical reaction cartridge.

Preferably, the opening is sealed by heat-sealing an end portion of the opening of the sealing member.

According to the embodiments of the present invention, the following effect can be obtained. That is, after the sample is injected, by sealing the insert section, pollution caused by the leaking and the exposure of the sample is prevented to increase safety. Thus the chemical reaction cartridge can be handled safely when used for examining and when discarded.

The entire disclosure of Japanese Patent Application No. 2007-000395 filed on Jan. 5, 2007 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A chemical reaction cartridge comprising:
an elastic member as a component;
a flow path and a plurality of chambers which are connected to each other by the flow path, the flow path or the chambers or both of the flow path and the chambers being partially blocked by applying external pressure to the elastic member from outside so that a fluid substance in the flow path or in the chambers is moved or blocked, and one of the chambers being a sample collecting chamber to temporarily retain a sample supplied from outside;
an insert section to insert an injection needle to inject the sample into the sample collecting chamber; and
a sealing member in which an opening to accept the injection needle inserted into the insert section is formed, and the opening is sealed to seal the insert section.

2. The chemical reaction cartridge of claim 1, wherein the sealing member comprises one of a rail fastener structure, a bonding sealing and an adhesive sealing for sealing the opening.

3. The chemical reaction cartridge of claim 1, wherein the sealing member has a saclike shape so as to cover an entire cartridge main body.

4. The chemical reaction cartridge of claim 3, comprising:
a substrate made of a rigid body to maintain a form of a surface on which the flow path and the plurality of chambers are formed, the substrate being provided on a back surface of the cartridge main body, wherein
an unevenness to lock the cartridge main body when a position of the cartridge is determined, is formed on a back surface of the substrate.

5. The chemical reaction cartridge of claim 3, wherein a light blocking property is given to an entire or a part of the sealing member.

6. The chemical reaction cartridge of claim 5, wherein a detection window section which has transparency is provided in the sealing member at a portion which covers one of the plurality of chambers in which an object to be optically detected is housed.

7. The chemical reaction cartridge of claim 3, wherein a metal film is provided in the sealing member at least at a portion which covers one of the plurality of chambers in which an object to be heated from outside is housed.

8. A method of using the chemical reaction cartridge of claim 1, comprising:
inserting the injection needle into the insert section through the opening;
injecting the sample into the sample collecting chamber through the injection needle;
removing the injection needle;
sealing the opening; and
using the chemical reaction cartridge to examine the sample, in a state of the opening being sealed.

9. The method of using the chemical reaction cartridge, of claim 8, comprising:
inserting the injection needle into the insert section through the opening;
injecting the sample to the sample collecting chamber through the injection needle;
removing the injection needle;
sealing the opening;
using the chemical reaction cartridge to examine the sample, in the state of the opening being sealed; and
discarding the chemical reaction cartridge.

10. The method of using the chemical reaction cartridge, of claim 8, wherein the opening is sealed by heat-sealing an end portion of the opening of the sealing member.
